(19) United States
(12) Patent Application Publication
(10) Pub. No.: US 2015/0003080 A1
(43) Pub. Date: Jan. 1, 2015

(54) LIGHT EMITTING DIODE MODULE

(71) Applicant: ADVANCED OPTOELECTRONIC TECHNOLOGY, INC., Hsinchu Hsien (TW)

(72) Inventors: CHAO-HSIUNG CHANG, Hukou (TW); PIN-CHUAN CHEN, Hukou (TW); HOU-TE LIN, Hukou (TW); LUNG-HSIN CHEN, Hukou (TW); WEN-LIANG TSENG, Hukou (TW)

(21) Appl. No.: 14/310,486

(22) Filed: Jun. 20, 2014

(30) Foreign Application Priority Data
Jun. 28, 2013 (CN) 201310265025X

(51) Int. Cl. F21K 99/00

(52) U.S. Cl. CPC F21K 9/50
USPC 362/311.02

(57) ABSTRACT

An LED module includes a PCB with a first electrode and a second electrode formed thereon, an LED mounted on the PCB, a lens mounted on the PCB and covering the LED. The LED includes a base, an LED die mounted on the base, and a packaging layer arranged on the base and covering the LED die therein. The base is flat. The lens includes a bottom surface, a first light output surface extending from the bottom surface, a second light output surface extending upwardly from a central of the first light output surface and away from the bottom surface, and a reflecting surface recessing downwardly from a top end of the second light output surface and oriented towards the bottom surface. A chamber is defined in the bottom surface to receive the LED therein.

### FIELD

The disclosure generally relates to light sources, and more particularly to a light emitting diode (LED) module having a wide illumination range and an even light distribution in the illumination range.

### BACKGROUND

LEDs have many beneficial characteristics, including low electrical power consumption, low heat generation, long lifetime, small volume, good impact resistance, fast response and excellent stability. These characteristics have enabled the LEDs to be widely used as a light source in electrical appliances and electronic devices.

A conventional LED module generally generates a smooth round light field. The light emitted from the LED is mainly concentrated at a center thereof. The light at a periphery of the LED is relatively poor and can not be used to illuminate. Therefore, the LED cannot be used in a plurality of devices which require a wider illumination range.

### BRIEF DESCRIPTION OF THE DRAWINGS

FIG. 1 is a cross-sectional view of an LED module according to an exemplary embodiment of the present disclosure.

FIG. 2 is an exploded view of the LED module of FIG. 1.

FIG. 3 is a cross-sectional view of an LED of the LED module of FIG. 1.

FIG. 4 is a top view of the LED of the LED module of FIG. 1.

FIG. 5 is top view of a lens of the LED module of FIG. 1.

### DETAILED DESCRIPTION

An embodiment of an LED module 10 in accordance with the present disclosure will now be described in detail below and with reference to the drawings.

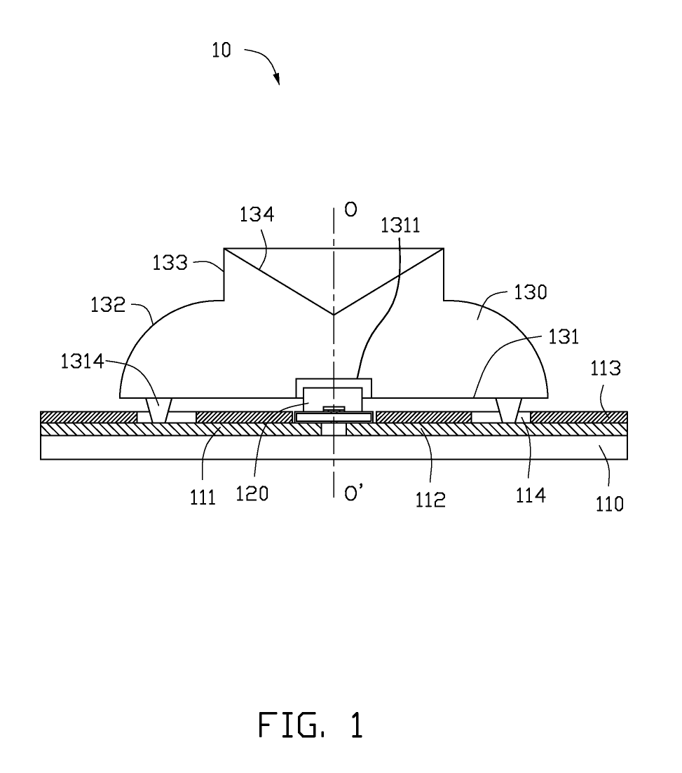

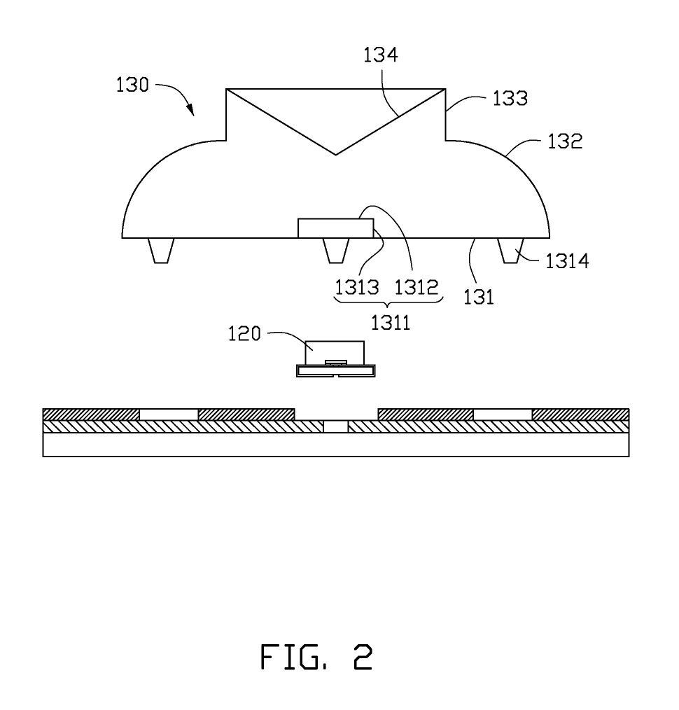

Referring to FIGS. 1-2, an LED module 10 in accordance with an exemplary embodiment of the disclosure includes a printed circuit board (PCB) 110, an LED 120 mounted on the PCB 110, and a lens 130 arranged on the PCB 110 and covering the LED 120.

The PCB 110 is a flat plate. A first electrode 111 and a second electrode 112 are formed on a top surface of the PCB 110 and electrically insulated from each other. The PCB 110 further includes a reflecting layer 113 formed on top surfaces of the first electrode 111 and the second electrode 112. The reflecting layer 113 reflects light emitted from the LED 20 and radiated towards the PCB 120 upwardly. In this embodiment, a material of the reflecting layer 113 is selected from aluminum, copper, silver, palladium and so on. A plurality of mounting holes 114 is defined in the reflecting layer 113 to engage in the lens 130. The LED 120 is received in one of the mounting holes 114.

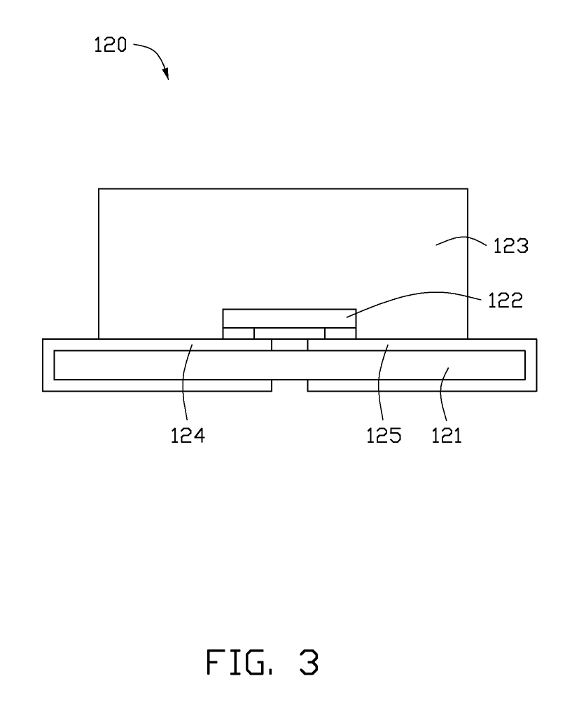

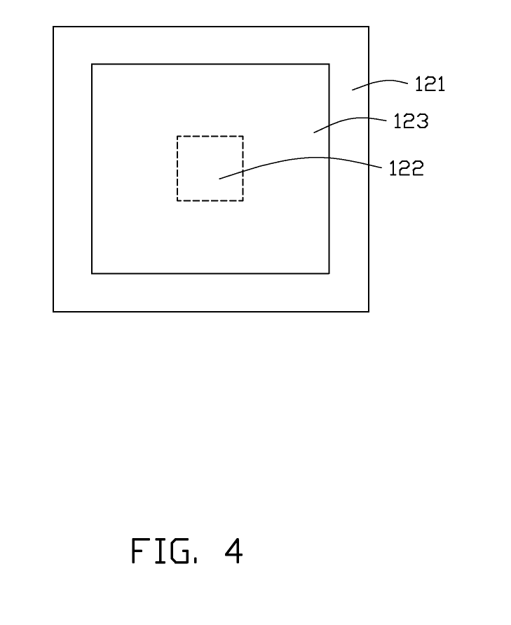

Referring also to FIGS. 3-4, the LED 120 includes a base 121, an LED die 122 mounted on a top surface of the base 121, and a packaging layer 123 covered the LED die 122 and arranged on the top surface of the base 121. The base 121 is a flat plate. A section of the packaging layer 123 parallel to the base 121 is square. A length/width of the section of the packaging layer 123 is varied between 1.5 mm to 1.8 mm. A radiated angle of the LED die 122 is larger than 140 degrees. In this embodiment, a first connecting electrode 124 and a second connecting electrode 125 are formed on the base 121. The first connecting electrode 124 and the second connecting electrode 125 are electrically insulated from each other. The first connecting electrode 124 and the second connecting electrode 125 are formed on opposite ends of the base 121 and each of them extends from the top surface to a bottom surface of the base 121. A bottom portion of the first connecting electrode 124 directly contacts the first electrode 111 and electrically connects the first electrode 111. The second connecting electrode 125 directly contacts the second electrode 112 and electrically connects the second electrode 112. Therefore, the LED die 122 is electrically connected to the PCB 110.

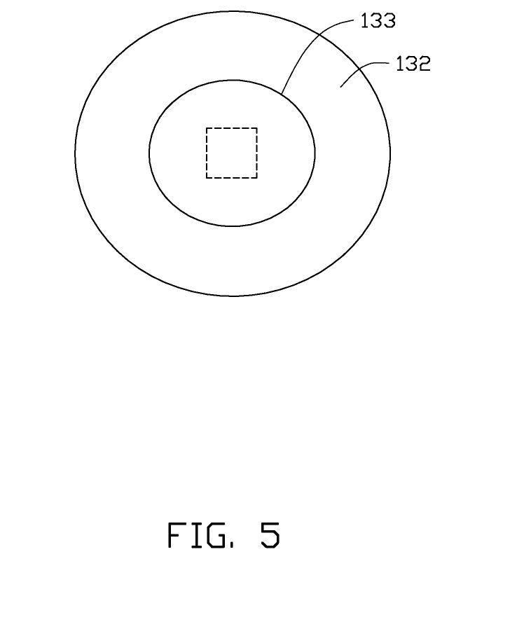

Referring to FIGS. 1 and 5, the lens 130 includes a bottom surface 131, a first light output surface 132 extending from a periphery of the bottom surface 131, a second light output surface 133 extending upwardly from a central of the first light output surface 132 and away from the bottom surface 131, and a reflecting surface 134 recessing downwardly from a top end of the second light output surface 132 and oriented towards the bottom surface 131. A material of the lens 130 is selected from polymethyl methacrylate, polycarbonate, or glass. In this embodiment, the lens 130 has an optical axis OO′, and the lens 130 is symmetrical relative to the optical axis OO′.

The bottom surface 131 is planar. A chamber 1311 is defined in a central of the bottom surface 131 to receive the LED 120 therein. In this embodiment, the 1311 is cuboid and includes a top surface 1312 and side surfaces 1313 connecting the top surface 1312 and the bottom surface 131. The side surfaces 1312 are perpendicular to the bottom surface 131. The top surface 1312 is parallel to the bottom surface 131. The lens 130 further includes a plurality of mounting poles 1314. The mounting poles 1314 are arranged near a periphery of the bottom surface 131 and extend downwardly from the bottom surface 131. When the lens 130 is assembled to the PCB 110, the mounting poles 1314 are inserted in the mounting holes 114 of the reflecting layer 113 to fix the lens 130 to the PCB 110. A gap is defined between the bottom surface 131 and the reflecting layer 113.

The first light output surface 132 is convex. An angle between the bottom surface 131 and a tangent plane of any point on the first light output surface 132 is less than 90 degrees. Specifically, a distance between any point on the first light output surface 132 and the bottom surface 131 is gradually decreased along a direction away from the optical axis OO′.

The second light output surface 133 extends upwardly from the central of the first light output surface 132. In this embodiment, the second light output surface 133 is cylindrical and perpendicular to the bottom surface 131.

The reflecting surface 134 recesses downwardly from the central of the first light output surface 132 and is cone. In this embodiment, the reflecting surface 134 has a cone angle not larger than 120 degrees.

In present disclosure, the LED 120 is received in the chamber 1311. Light emitted from the LED 120 radiates through the chamber 1311 and into the lens 130. A portion of light directly radiates towards and through the first light output surface 132 and second light output surface 133 to illuminate, a portion of light radiates to the reflecting surface 134 and is reflected by the reflecting surface 134, and the reflected light radiates towards and through the first light output surface 132 and second light output surface 133 to illuminate. Since the base 121 is a flat plate, and a horizontal section of the packaging layer 123 is square, light emitted from the LED 120 is not concentrated by the base 121 and the packaging layer 123 and can radiated to a wider illumination range. As a result, the LED module 10 has a larger illumination angle. Further, the reflecting surface 134 recessing towards the bottom surface 131 is a benefit for the reflecting surface 134 reflecting a portion of light concentrated from a central region of the lens 130 to a periphery of the lens 130 through the first light output surface 132 and the second light output surface 133. Thus, light is evenly distributed in the illumination range.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode (LED) module comprising:
a printed circuit board (PCB), wherein a first electrode and a second electrode are formed on a side of the PCB;
an LED mounted on the PCB, the LED comprising a base, an LED die mounted on the base, and a packaging layer arranged on the base and covering the LED die therein, the base being flat; and
a lens mounted on the PCB and covering the LED, the lens comprising a bottom surface in which a chamber is defined to receive the LED, a first light output surface extending from a periphery of the bottom surface, a second light output surface extending upwardly from a central of the first light output surface and away from the bottom surface, and a reflecting surface recessing downwardly from a top end of the second light output surface and oriented towards the bottom surface.

2. The LED module of claim 1, wherein the lens has an optical axis OO′, and the lens is symmetrical relative to the optical axis OO′.

3. The LED module of claim 2, wherein the first light output surface is convex, an angle between the bottom surface and a tangent plane of any point on the first light output surface is less than 90 degrees.

4. The LED module of claim 3, wherein a distance between any point on the first light output surface and the bottom surface is gradually decreased along a direction away from the optical axis OO′.

5. The LED module of claim 1, wherein the second light output surface is cylindrical and perpendicular to the bottom surface.

6. The LED module of claim 1, wherein the reflecting surface is cone.

7. The LED module of claim 6, wherein the reflecting surface has a cone angle less than or equal to 120 degrees.

8. The LED module of claim 1, wherein a length/width of the section of the packaging layer 123 is varied between 1.5 mm to 1.8 mm.

9. The LED module of claim 1, wherein a radiated angle of the LED die is larger than 140 degrees.

10. The LED module of claim 1, wherein the chamber is cuboid.

11. The LED module of claim 1, wherein the lens comprises a plurality of mounting poles extending extend downwardly from the bottom surface.

12. The LED module of claim 11, wherein a reflecting layer is formed on the PCB and covers the first electrode and the second electrode, a plurality of mounting holes is defined in the reflecting layer, and the mounting poles are inserted the mounting holes to fix the lens to the PCB.

13. The LED module of claim 1, wherein a first connecting electrode and a second connecting electrode are formed on the base and respectively contact the first electrode and the second electrode.

14. The LED module of claim 13, wherein the first connecting electrode and the second connecting electrode are formed on opposite ends of the base and each of them extends from a top surface to a bottom surface of the base.

15. The LED module of claim 1, wherein a gap is defined between the bottom surface of the lens and the PCB.

16. The LED module of claim 1, wherein a section of the packaging parallel to the base being square.
